(19) United States
(12) Patent Application Publication
(10) Pub. No.: US 2003/0175438 A1
(43) Pub. Date: Sep. 18, 2003

(54) Treatments of solid substrates to enhance durability of treatments placed thereon

(76) Inventor: John A. Reeve, Midland, MI (US)

Correspondence Address: Robert L. McKellar, Suite #2, 816 West Wackerly St., Midland, MI, 48640-2730, US

(21) Appl. No.: 10/052,002

(22) Filed: Jan. 17, 2002

(51) Int. Cl. B08B 3/00

(52) U.S. Cl. 427/387

(57) ABSTRACT

Treatments for solid substrates to enhance the application and durability of the treatments that are applied to such substrates wherein treating agents for such substrates, such as antimicrobially effective organofunctional silanes, are combined with dianion containing materials to obtain such treatments.

### BACKGROUND OF THE INVENTION

The invention disclosed and claimed herein deals with treatments for solid substrates to enhance the durability and application rate of the treatments that are applied to such substrates.

There are many patents and publications disclosing silanes, siloxanes, and other silicon-containing materials that are bondable to solid substrates. In addition, there are many such publications dealing with the use of the silanes, siloxanes and other silicon-containing materials to bond other materials to solid substrates, and such applications are old in the art.

For example, U.S. Pat. No. 5,051,129, that issued on Sep. 24, 1991 teaches that a wide variety of masonry products can be protected from the damaging effects of water penetration by the application of an aqueous solution containing a product obtained by combining water with an alkyltrialkoxysilane such as methyltrimethoxysilane and a water soluble silane coupling agent such as N-(2-aminoethyl)-3-aminopropyltrimethoxy silane.

Further, Narula, et al. in U.S. Pat. No. 5,205,860, that issued on Apr. 27, 1993 shows the use of surface treating compositions for excluding water penetration. The material described therein consists of combining water, an alkyltrialkoxysilane or blends of alkyltrialkoxysilanes, a silane coupling agent, and an aqueous silicone emulsion of an anionically stabilized hydroxyl end blocked polydiorganosiloxane, amorphous silica and an organic tin salt, the tin salt ostensibly used as a catalyst for the system.

Roth, et al., in U.S. Pat. No. 5,250,106 that issued on Oct. 5, 1993, teaches a process for rendering masonry water repellent. The masonry is treated with a combination that is an organoalkoxysilane and/or an organosiloxane containing alkoxy groups and a water-soluble organic or inorganic acid salt of an organopolysiloxane.

Rich, et al., in U.S. Pat. No. 5,527,931 that issued on Jun. 18, 1996 teaches aqueous dispersible oil and water repellent silane masonry penetrants. The essence of the invention is the use of silanes compounds comprising hydrophilic, hydrophobic, and oleophobic, components which can effectively repel both water and oil based challenges.

In an example of bonding functionalized substances to solid substrates using silane chemistry, attention is directed to U.S. Pat. No. 6,258,454 that issued Jul. 10, 2001 to Lefkowitz, et al. in which low surface energy functionalized surfaces on solid supports are provided by treating a solid support having hydrophilic moieties on the surface, with a derivatizing composition containing a mixture of silanes. The resulting products are useful in chemistry and biotechnology such as solid phase chemical synthesis, wherein initial derivatization of a substrate surface enables synthesis of polymers such as oligonucleotides and peptides on the substrate itself.

It is also known in the prior art to treat solid substrates to create antimicrobial surfaces on them. Such processes are, for example, the treatment of fibers and fabrics. Common in the art is to treat such fibers and fabrics with silicones that have antimicrobial activity associated with them. U.S. Pat. No. 5,562,761, issued to Dirschl, et al., on Oct. 8, 1996 discloses the treatment of sheet materials made of fibrous materials, with aqueous dispersions that contain dihydroxypolyorganosiloxanes, amino functional silanes and cyclic oligosiloxanes and/or reaction products of these materials. It should be noted that the amino functional silanes that are described therein have the general formula YX₂Si(CHZ)ₚNH(CHZ_{w}NH)_{q}H, that are primary and secondary amino functional silanes.

Also described in the prior art is the use of quaternary ammonium alkoxysilanes which are taught in a wide variety of U.S. patents, namely, U.S. Pat. No. 3,560,385 that issued to Roth on Feb. 2, 1971; U.S. Pat. No. 3,794,736, that issued on Feb. 25, 1974 to Abbott, et al; U.S. Pat. No. 3,814,739, that issued to Takeda on Jun. 4, 1974. Additionally, the U.S. patents that teach that these compounds possess certain antimicrobial properties which make them valuable and very useful for a variety of surfaces, substrates, instruments, applications, and the like, are U.S. Pat. No. 3,730,701, that issued to Isquith, et al. on May 1, 1973; U.S. Pat. No. 3,794,736 noted supra; U.S. Pat. No. 3,860,709, that issued to Abbott, et al. on Jan. 14, 1975; U.S. Pat. No. 4,282,366, that issued to Eudy on Aug. 4, 1981; U.S. Pat. No. 4,408,996, that issued to Baldwin on Oct. 11, 1983; U.S. Pat. No. 4,414,268, that issued to Baldwin on Nov. 8, 1983; U.S. Pat. No. 4,504,541, that issued to Yasuda on Mar. 12, 1985; U.S. Pat. No. 4,615,937, that issued to Bouchette on Oct. 7, 1986, and U.S. Pat. No. 4,692,374, that issued to Bouchette on Sep. 8, 1987. None of these prior art references show the use of dianions to enhance the durability and rate of application of the treatments on solid substrates, and moreover, none of these references teach or suggest that the effect of the treatment can be enhanced by such a method, for example, the enhanced antimicrobial effect of those materials having antimicrobial properties.

### BRIEF SUMMARY OF THE INVENTION

Thus, what is disclosed and claimed herein as one embodiment of the invention is a method of treating a solid substrate, wherein the method comprises providing a solid substrate and contacting the solid substrate with an aqueous solution of at least one compound having a dianion, and thereafter, contacting the solid substrate so treated, with a silicon-containing material capable of reacting at or near the solid substrate surface.

In addition, there is another embodiment of this invention which is a method of treating a solid substrate wherein the method comprises providing an aqueous solution of at least one compound having a dianion and a silicon-containing material capable of reacting at or near the surface of the solid substrate and thereafter, contacting the solid substrate with the aqueous solution.

There is still another embodiment of this invention which is a method of treating a solid substrate wherein the method comprises providing an aqueous solution of a silicon-containing material and contacting a solid substrate with the aqueous solution and thereafter contacting the solid substrate with an aqueous solution of at least one compound having a dianion.

Yet another embodiment of this invention is a method of treating a treated solid substrate wherein the method comprises providing a chemically treated solid substrate and contacting the chemically treated solid substrate with an aqueous solution of at least one compound having a dianion and thereafter treating the solid substrate with a silicon-containing material capable of reacting with at least the chemical used to chemically treat the solid substrate

Turning to another embodiment of this invention there is a method of treating a treated solid substrate wherein the method comprises providing a chemically treated solid substrate and contacting the chemically treated solid substrate with a silicon-containing material capable of reacting with at least the chemical used to chemically treat the solid substrate and thereafter treating the solid substrate with an aqueous solution of at least one compound having a dianion.

Turning to yet another embodiment of this invention there is a method of treating a treated solid substrate wherein the method comprises providing an aqueous solution of at least one compound having a dianion and a silicon-containing material capable of reacting with at least the chemical used to chemically treat the solid substrate at or near the surface of the solid substrate and contacting the solid substrate with the aqueous solution.

### DETAILED DESCRIPTION OF THE INVENTION

In more detail, the invention deals with a method of treating a solid substrate to render the treatment on the substrate more effective, wherein the efficacy of the treatment is enhanced by the dianion treatment and, in addition, the effect is made more durable than the treatment of the solid substrate using the treatment agents alone.

For purposes of this invention, any solid substrate may be treated to obtain the intended effect. For example, substrates such as fibers, woven and nonwoven fabrics, such as cotton, polyesters, nylon, rayon, acrylics, polyurethanes, polypropylenes and polyethylenes may be treated to obtain this effect. In addition, substrates that are not fibers and fabrics may be treated by the methods of this invention, for example, coatings, cast or molded sheets or articles of polyesters, nylon, rayon, acrylic, polyurethane, polypropylene and polyethylene may be effectively treated by the methods of this invention. In addition, paper and paper products, such as cardboard, wood, and other hard surfaces may be treated by the methods of this invention, as well as mineral surfaces such as stone, concrete, rock, and the like. Preferred solid substrates are the fibers, nonwoven fibers and fabrics and especially preferred are the cotton, PET, nylon, rayon, and polyester fibers and fabrics.

“Contacting” for purposes of this invention, means any method by which the treating agents and/or dianions can be brought to the solid substrate, or the solid substrate can be brought to the treating agent and/or dianion solution.

For purposes of this invention, any compound that contains a dianion therein is useful in the invention. Most preferred are the inorganic dianionic compounds, for example, those compounds containing SO₄⁻⁻, CO₃⁻⁻, HPO₄⁻⁻, Cr₂O₇^{--,} CrO₄⁻⁻, MnO₃⁻⁻, MnO₄⁻⁻, WO₄⁻⁻, and C₂O₄⁻⁻. Most preferred are the SO₄⁻⁻, CO₃⁻⁻, PO₄⁻⁻, and C₂O₄⁻⁻ dianions, and especially preferred are the CO₃⁻⁻ and C₂O₄⁻⁻ dianions.

Antimicrobial agents that are useful in this invention are, for example, quaternary ammonium silicon-containing materials and can be selected from the group consisting of quaternary ammonium silanes, quaternary ammonium containing oligomer siloxanes, quaterny ammonium containing polymeric siloxanes, quaternary ammonium di- or tri-silanes, silanes or siloxanes having hydrocarbon linkages such as —Si(C)ySi—, wherein _{y} has a value of 1 to 12, and quaternary ammonium containing siloxane/organic copolymers.

Examples of quaternary ammonium silanes that are useful in this invention are those having the general formula (RO)ₙSi{(CₓH₂ₓ)N⁺(R²)_{b}(R³)_{3-b}X⁻}₄₋ₙ, wherein ₙ has a value of 1, 2, or 3; ₓ has a value of 1 to 20; R is an alkyl group having 1 to 6 carbon atoms; each R² is an alkyl group selected from the group consisting of 1 to 6 carbon atoms, X is a halogen, each R³ is an alkyl group selected from the group consisting of 1 to twenty carbon atoms and b has a value of 0, 1, 2, or 3.

Two silanes that are especially preferred for this invention are N,N-dimethyl-N-Octadecyl-3-(trimethoxysilyl)propanaminium chloride and N,N-Didecyl-N-Methyl-3-(trimethoxysilyl)propanaminium chloride. Most preferred is the N, N-dimethyl-N-Octadecyl-3-(trimethoxysilyl)propanaminium chloride.

An example of an oligomeric siloxane is

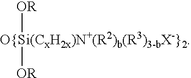

An example of a polymeric siloxane that is useful in this invention is

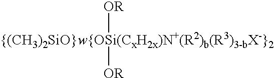

wherein w has a value of 1 or greater. Another example of such a polymeric siloxane is

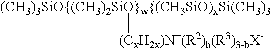

wherein the value of w is 1 or greater, and the value of x is from 1 to 12. An example of a disilane of this invention is

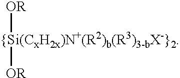

An example of a silicon-containing material that contains an —Si(C)ySi— bond is

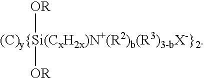

In this type of material, the value of y is on the order of about 1 to 4, and most preferably, it is 1 to 3.

A material that is useful in this invention that is a silicone/organic copolymer has the general formula

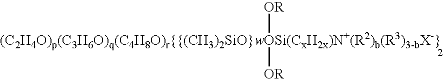

wherein the value of w is 1 to 10, the value of p, q, and r can each be from 0 to 25, and further provided that at least one of p, q or r has a value of at least one and the sum of p, q, and r does not exceed 25.

Especially useful silanes that are useful in this invention, for example to provide water proofing to mineral surfaces are alkoxysilanes, preferably trialkoxysilanes that are known in the art for such uses and most preferably is methyltrimethoxysilane.

It is contemplated within the scope of this invention to apply the method to situations wherein hydrolysable silanes are used to bond other materials to solid substrates, for example enzymes, oligonucleotides, peptides, release agents, anti-clotting treatments for blood storage and handling, reflective coatings, anti-reflective coatings, anti-fouling coatings, adhesion promoters, interpenetrating polymer networks, fluorescent coatings, luminescent coatings, and the like.

Turning now to the various methods which are the embodiments of this invention, it should be noted that the preferred method for this invention is to prepare an aqueous solution of the treating agent separately from an aqueous solution of the dianion compound used in this invention, or prepare an aqueous solution of a combination of the treating agent and the dianion compound.

The solid surface can be treated by any method that is convenient for the type of substrate being prepared. For example, if the substrate is a fiber, nonwoven or a fabric, then they can be immersed in the aqueous solutions.

In this invention, the “pretreatment” is one selected method for treating the substrate and consists of preparing the solution of the treating agent, preparing the solution of the dianion, contacting the substrate with the solution of the dianion, and then contacting the dianion treated substrate with the treating agent solution. Thereafter, the excess solution is removed from the substrate, and the substrate is allowed to dry.

In this invention, in preparing the treating agent solution, it is preferred to allow the alkoxy groups on the treating agent to hydrolyze to the silanol form before actually contacting the substrate.

In this invention, the “co-treatment” is another selected method for treating the substrate and consists of preparing a solution of the treating agent in combination with the dianion, contacting the substrate with the co-solution, and thereafter, removing the excess solution from the substrate and allowing the substrate to dry.

In this invention, the “post-treatment” is yet another selected method for treating the substrate and consists of preparing a solution of the treating agent, preparing a separate solution of the dianion, treating the substrate with the treating agent solution, and then treating the substrate with the dianion solution, removing the excess solution, and thereafter, allowing the substrate to dry.

The particular method that is used is dependent on the type of substrate that is being treated, in that, one would use the method that gives the optimum performance for that particular type of substrate. The type of substrate and the type of treating agent that is used will generally dictate the dianion that is needed and simple, quick testing will suffice to make such a determination.

Quite often, the substrates have been prior treated with some chemical treatment. For example, fabrics, and sometimes, fibers, are treated to make them more receptive to dyes, or softeners, or the like, in common textile processes, such as boiling scours, disperse dyeing and other wet end treatments.

It has been found that the methods of this invention can be used on substrates that have been already chemically treated. It appears, but the inventor herein does not want to be held to such a theory, that the treatments of the methods of this invention can complement such chemical treatments and it is theorized that the dianions of this invention may catalyze the treatments of this invention in reaction with the chemicals already present on the surfaces of the substrates. It has been noted by the inventor herein that the enhancement of the treatment efficacy on such substrates has been achieved by the methods of this invention.

The following examples illustrate the practical application of the methods of this invention.

### EXAMPLES

### Example 1

### Pre-Treatment with Carbonate

Sample Preparation: Fabric samples were obtained from the JoAnn fabric chain and were commercial fabrics. The fabrics were cut into rectangular size and were about 1½ inches by 2 inches, and were treated in 0.15 weight percent active antimicrobial agent placed in an Erlenmeyer flask. The agent used in this example was N, N-dimethyl-N-Octadecyl-3-(trimethoxysilyl)propanaminium chloride. The treatment solutions were allowed to hydrolyze from the trimethoxysilyl form to the trisilanol form before adding the fabrics. This takes only a few minutes to essentially complete. The solution temperature was raised to 100° C. before treating the fabrics for 60 seconds by immersion in the solutions with moderate agitation of the solution within the flask. After removing the samples from the hot solution, they were nip rolled to remove excess liquid. Wet Weight Pickup (WWP) was targeted to 100%. The samples were air dried before testing unless otherwise noted. The Extraction, stated in percent, was measured using the Bromphenol Blue Extraction Method using spectrophotometric determination. This method is CTM 0824, which has been modified for use herein in the following manner. The chlorinated solvent has been eliminated and the wavelength is 595 nm. Further, Dow Corning® A521 has been substituted for the Triton.RTM. X-100 wetting agent of the test. What is measured is the diminution of the BPB Absorbance at 595 nm relative to the BPB standard solution and it is reported in percent Extraction. Antimicrobial efficacy was determined using the CTM-0923 Dynamic Shake Flask Test unless otherwise stated.

Pre-treatment is the addition of the fabric to a 0.20 Molar solution of the anion prior to treating with the antimicrobial agent unless the molality is stated otherwise. The anion pre-treatment may be pursued at ambient temperature to 100° C., and is generally agitated for 60 seconds. This is a two-step process that works best if the WWP is from 100 to 500%. The results are shown in Table I, infra, wherein “AMT” throughout the examples means antimicrobial treatment. The material providing the dianion in this first example was sodium bicarbonate. The efficacy results are shown on Table II, infra.

### Example 2

### Co-Treatment with Phosphate

Fabrics, obtained as in example 1, were cut into rectangular size and treated in 0.15 weight percent active antimicrobial agent as was used in example 1. The treatment solutions, comprised of the antimicrobial set forth in example 1, were allowed to hydrolyze from the trimethoxysilyl form to the trisilanol form before the fabrics were added to the flasks containing the solutions. The solution temperature was raised to 100° C. before treating the fabrics for 60 seconds with moderate agitation of the flask. After removing the samples from the hot solution, they were nip rolled to remove excess liquid. WWP was approximately 100%. Samples were air dried before testing. The extraction percentage was measured using the same methods as indicated in example 1, and the efficacy was determined as in example 1.

For purposes of this invention, “co-treatment” is the addition of the fabric to a 0.20 molar solution of the dianion unless the molality is stated otherwise, plus 0.15 WPA antimicrobial agent. The co-treatment was carried out at 100° C., and the fabric was moderately agitated for 60 seconds. The results are found in Table III, infra. The material used for the dianion source was sodium biphosphate.

### Example 3

### Co-Treatment with Carbonate

The samples were handled just as those in example 2. The antimicrobial solution, comprised of the same antimicrobial agent as was used in example 1, was 0.15 weight percent active (WPA). The testing was handled exactly as set forth in examples 1 and 2. The results are set forth in Tables IV and V, respectively, infra. The source of the carbonate dianion was sodium bicarbonate.

### Example 4

### Pre-Treatment with Sulphate

This example was handled similar to example 1. The treating agent was the antimicrobial agent of example 1 and the source of the sulphate dianion was hydrated magnesium sulphate (7H₂O). The results of testing can be found on Tables VI, infra.

### Example 5

### Pre-Treatment with Oxalate

This example was handled similar to example 1. The treating agent was the antimicrobial agent of Example 1 and the source of the oxalate dianion was sodium oxalate. The results of testing can be found on Tables VII and VIII, respectively, infra.

### Example 6

### Co-Treatment with Oxalate

The samples of this example were handled just as those were in example 3. the antimicrobial agent of example 1 was used and the source of the oxalate dianion was sodium oxalate. The results of testing can be found on Tables IX and X, respectively, infra.

### Example 7

### Carbonate Treatment with Cure

Fabric samples were obtained from JoAnn Fabrics chain and were commercial fabrics. The fabric samples were cut into rectangular size and treated in 0.15 weight percent active antimicrobial agent as was used in example 1. The treatment solutions were allowed to hydrolyze from the trimethoxysilyl form to the trisilanol form before adding the fabrics. The solution temperature was raised to 100° C. before treating the fabrics for 60 seconds with moderate agitation. After removing the samples from the hot antimicrobial solution, they were nip rolled to remove excess liquid. Wet Weight Pickup (WWP) was approximately 100%. Both post-treatment with carbonate and co-treatment with carbonate were used to assess the time and temperature effect of curing conditions

Samples were air dried before testing. The % extraction was measured using the BPB extraction Method using spectrophotometric determination at 595 nm. Antimicrobial efficacy was determined, when applicable, using the ASTM CTM 0923 Dynamic Shake Flask Test. The substrate may be either wet or dry. The testing results can be found on Tables XI and XII, respectively, infra.

### Example 8

### Demonstration of Strike Rate/pH/with Carbonate Co-Treatment

The antimicrobial agent used in this example was the same as that used in example 1. The samples were handled the same as in example 1 with the exception of the following. Samples were air and/or oven dried before testing. The % Extraction was measured using the BPB Extraction Method using spectrophotometric determination at 595 nm. If determined, antimicrobial efficacy was determined using the CTM-0923 Dynamic Shake Flask Test. Co-treatments the addition of the fabric to a 0.20 molar solution of the anion plus 0.15 WPA antimicrobial agent. The co-treatment is carried out at 100° C., and the fabric was moderately agitated for 60 seconds. The antimicrobial treatment is the addition of the fabric to a solution of 0.15 WPA antimicrobial agent held at 100° C. with moderate agitation for 60 seconds. Excess solution is removed from the samples, and the WWP is determined by weighing. Boiling was done with 200 milliliters of distilled water in a glass container in a microwave oven. Power setting was 30%, and the solution was gently boiled for 30 minutes. Sample size was nominally 1 gram and fresh water was used for each boiling study. The testing results can be found on Table XIII to XIV, respectively, infra. To differentiate between the application rate of the antimicrobial on the fabric, 25% of the normal sample size, or 0.25 grams of fabric was used to obtain the BPB Extraction values that ranged between 5 and 99%. This yielded values of percent BPB extraction that were in the linear range of the test procedure. Using larger samples creates an inaccurate test.

### Example 9

### Co-Treatment with Phosphate

The samples were handled as above, with the following exceptions. A solution of the anion was prepared at 0.4 Molar concentration, and a solution of the antimicrobial agent of example 1 at 0.30 WPA was made up and allowed to hydrolyze. The solution temperatures were raised to 85° C. and the two were combined to yield the final treatment solution. The pH of the mixture was approximately 9, as measured with a pH test strip. The temperature was raised to 100° C. before treating the fabrics for 60 seconds with moderate agitation. After removing the sample from the hot antimicrobial agent, they were nip rolled to remove excess liquid. Wet Weight Pickup (WWP) was approximately 100% and treated sample weights were recorded.

Samples were oven dried at 130° C. for 5 minutes before testing. The % Extraction was measured using the BPB Extraction Method with spectrophotometric determination at 595 λ. Antimicrobial efficacy, when tested, was determined using the CTM-0923 Dynamic Shake Flask Test. Co-treatment is the addition of the fabric to a 0.20 molar solution of the anion plus 0.15 WPA antimicrobial agent. The co-treatment is carried out at 100° C., and the fabric was moderately agitated for 60 seconds. The testing results can be found on Table XV to XVI, respectively, infra.

### Example 10

### Co-Treatment with Oxalate

The samples were handled as in Example 9, except that oxalate was used in the place of phosphate. The source of the oxalate was sodium oxalate. The testing results can be found in Table XVII, infra.

TABLE I

| | | Type of Treatment | | | | | | |
|---|---|---|---|---|---|---|---|---|
| | | | | AMT | % BPB | | carbonate | % BPB |
| | | cont. | AMT | boiled | Extraction | carbonate | boiled | Extraction |
| % Extraction | PET | 0 | 89 | 18 | −71 | 80 | 98 | +18 |
| @ 595 nm | RAYON | 0 | 90 | 35 | −55 | 62 | 89 | +27 |
| | NYLON | 0 | 82 | 45 | −37 | 52 | 59 | +7 |

* PET is a commercial polyethyleneterephthalate staple fiber used in pillow tow.

Conclusions: Durability of the antimicrobial treatment to boiling conditions as measured by the BPB Extraction procedure shows improvement after the 30 minute boil for samples pre-treated with carbonate anions. Loss of antimicrobial is seen by decrease in BPB Extraction in samples which are not pre-treated with the carbonate anions.

TABLE II

| | Efficacy - % Reduction | | |
|---|---|---|---|
| Treatment | PET | RAYON | NYLON |
| Control | 0 | 0 | 0 |
| AMT | 99 | 99 | 90 |
| AMT boiled 30 minutes | 99 | 19 | 84 |
| Pre-Treat with carbonate | 99 | 99 | 98 |
| dianion then AMT | | | |
| Pre-Treat with carbonate | 99 | 99 | 93 |
| dianion + AMT + | | | |
| boiled 30 minutes | | | |
| Test: CTM 0923 using E. coli | | | |

Conclusions: Antimicrobial efficacy of rayon and nylon fabrics samples pre-treated with carbonate show improvement after a 30 minute boil in water. The rate of application or strike rate of the antimicrobial is also increased using pre-treatment of carbonate as evidenced by the improved reduction of microbes in nylon and rayon fabrics.

TABLE III

| | % BPB EXTRACTION @ 595 nm | | | |
|---|---|---|---|---|
| Treatment Type | COTTON | PET | RAYON | NYLON |
| Control | 0 | 0 | 0 | 0 |
| AMT | 96 | 94 | 94 | 77 |
| AMT boiled | 95 | 20 | 50 | 20 |
| boiled 30 minutes | | | | |
| % Extraction change | −1 | −74 | −44 | −57 |
| AMT + Phosphate | 85 | 75 | 52 | 72 |
| AMT + phosphate | 90 | 96 | 90 | 55 |
| Boiled 30 minutes | | | | |
| % Extraction change | +5 | +21 | +38 | −17 |

Conclusions: Durability of the antimicrobial treatment to boiling conditions as measured by the BPB Extraction procedure shows improvement after the 30 minute boil for PET, Rayon and Nylon samples pre-treated with carbonate anions. Loss of antimicrobial is seen by decrease in BPB Extraction from 44 to 74% PET, Rayon and Nylon samples which are not pre-treated with the carbonate anions. Results on cotton demonstrate the affinity of the antimicrobial for the hydroxyl groups of the cellulose and the hydrophilic nature of cotton that provide high reactivity and formation of stable bonds without the dianions.

TABLE IV

| | % Extraction @ 595 nm | | |
|---|---|---|---|
| | | ACRYLIC | |
| Type of Treatment | COTTON | MODACRYLIC | NYLON |
| CONTROL | 0 | 0 | 0 |
| AMT | 95 | 91 | 70 |
| AMT boiled | 94 | 45 | 45 |
| % BPB EXTRACTION | −1 | −46 | −25 |
| CHANGE | | | |
| CARBONATE | 78 | 38 | 55 |
| CARBONATE BOILED | 93 | 87 | 59 |
| % BPB EXTRACTION | +15 | +49 | +4 |
| CHANGE | | | |

Conclusions: Durability of the antimicrobial treatment to boiling conditions as measured by the BPB Extraction procedure shows improvement after the 30 minute boil for acrylic/modacrylic and nylon samples co-treated with carbonate anions. Loss of antimicrobial is seen by decrease in BPB Extraction in samples that are not co-treated with the carbonate anions.

TABLE V

| | Efficacy - % Reduction | | |
|---|---|---|---|
| | | ACRYLIC/ | |
| TYPE OF TREATMENT | COTTON | MODACRYLIC | NYLON |
| CONTROL | 0 | 0 | 0 |
| AMT | 99 | 90 | 99 |
| AMT boiled 30 minutes | 99 | 84 | 19 |
| Carbonate | 99 | 98 | 99 |
| treatment + AMT | | | |
| Carbonate Treatment + | 99 | 93 | 99 |
| AMT + Boiled 30 minutes | | | |

Conclusions: Durability of the antimicrobial treatment to boiling conditions as measured by the BPB Extraction procedure shows improvement after the 30 minute boil for acrylic/modacrylic and nylon samples co-treated with carbonate anions. Loss of antimicrobial is seen by decrease in BPB Extraction in samples that are not co-treated with the carbonate anions.

TABLE VI

| | % EXTRACTION @ 595 nm | | | |
|---|---|---|---|---|
| Type of Treatment | COTTON | PET | RAYON | NYLON |
| CONTROL | 0 | 0 | 0 | 0 |
| AMT | 94 | 89 | 94 | 82 |
| AMT boiled | 94 | 26 | 44 | 11 |
| EXTRACTION CHANGE | 0 | −63 | −50 | −71 |
| SULPHATE | 61 | 87 | 62 | 73 |
| SULPHATE BOILED | 81 | 74 | 91 | 29 |
| EXTRACTION CHANGE | +20 | −13 | +29 | −44 |

Conclusions: Durability of the antimicrobial treatment to boiling conditions as measured by the BPB Extraction procedure shows improvement after the 30 minute boil for PET, rayon and nylon samples pre-treated with sulphate anions. Loss of antimicrobial is seen by decrease in BPB Extraction in samples that are not pre-treated with the sulphate anions.

TABLE VII

| | % BPB EXTRACTION @ 595 nm | | | |
|---|---|---|---|---|
| Treatment Type | COTTON | PET | RAYON | NYLON |
| CONTROL | 0 | 0 | 0 | 0 |
| AMT | 95 | 93 | 92 | 87 |
| AMT + boiled | 97 | 91 | 42 | 18 |
| % EXTRACTION CHANGE | +2 | −72 | −50 | −69 |
| OXALATE PRE-TREAT | 96 | 90 | 94 | 90 |
| OXALATE PRE-TREAT + | 97 | 26 | 47 | 27 |
| boiled | | | | |
| % EXTRACTION CHANGE | +1 | −54 | −47 | −63 |

Conclusions: Durability of the antimicrobial treatment to boiling conditions as measured by the BPB Extraction procedure is poor for samples with insufficient oxalate anion on the fabric in the pre-treatment step.

TABLE VIII

| | DSF - % REDUCTION | | | |
|---|---|---|---|---|
| Treatment Type | COTTON | PET | RAYON | NYLON |
| CONTROL | 0 | 0 | 0 | 0 |
| AMT | 99 | 99 | 99 | 99 |
| AMT + boiled 30 minutes | 99 | 91 | 94 | 22 |
| PRE-TREAT OXALATE + | 99 | 99 | 99 | 99 |
| AMT | | | | |
| PRE-TREAT OXALATE + | 99 | 99 | 95 | 67 |
| Boiled 30 minutes | | | | |

Conclusions: Antimicrobial efficacy of cotton, PET and rayon fabrics samples pre-treated with oxalate show microbial reductions of greater than 90% for all samples before and after a 30 minute boil in water. Only nylon showed a percent reduction less than 90%; pre-treatment with oxalate gave better efficacy that the sample which did not receive the anionic pre-treatment. The amount of antimicrobial added was sufficient such that the loss of material on boiling did not affect the ability of the treated fabric to achieve the efficacy for cotton, PET and rayon samples.

TABLE IX

| | % BPB EXTRACTION @ 595 nm | | | |
|---|---|---|---|---|
| Treatment Type | COTTON | PET | RAYON | NYLON |
| CONTROL | 2 | 2 | 2 | 2 |
| AMT | 93 | 87 | 92 | 85 |
| AMT + boiled | 92 | 14 | 52 | 19 |
| % EXTRACTION CHANGE | −1 | −73 | −40 | −66 |
| OXALATE | 60 | 84 | 20 | 66 |
| CO-TREATMENT | | | | |
| OXALATE | 87 | 91 | 50 | 68 |
| CO-TREATMENT (boiled) | | | | |
| % EXTRACTION CHANGE | +27 | +7 | +30 | +2 |

Conclusions: Durability of the antimicrobial treatment to boiling conditions as measured by the BPB Extraction procedure shows improvement after the 30 minute boil for samples co-treated with oxalate anions. Cotton and rayon samples did not show a significant improvement to boiling durability using the co-treatment of oxalate compared to those samples that did not receive any treatment.

TABLE X

| | DSF - % REDUCTION | | | |
|---|---|---|---|---|
| Treatment Type | COTTON | PET | RAYON | NYLON |
| CONTROL | 0 | 50 | 0 | 0 |
| AMT | 89 | 79 | 99 | 99 |
| AMT + boiled | 93 | 74 | 99 | 99 |
| AMT + OXALATE | 12 | 80 | 99 | 99 |
| CO-TREAT | | | | |
| AMT + OXALATE | 88 | 75 | 99 | 99 |
| CO-TREAT + boiled | | | | |

Conclusions: Antimicrobial efficacy of cotton, rayon and nylon fabrics samples co-treated with oxalate show essentially the same efficacy after a 30 minute boil in water. The PET sample showed a reduction of 50% for the untreated control and should be disregarded. The rate of application or strike rate of the antimicrobial was high using the co-treatment of oxalate such that excellent microbial reductions result for all samples.

TABLE XI

| Post-Treatment | Cure | No Boil | Boiled in H20 | |
|---|---|---|---|---|
| ID | Condition | % Extraction | % Extraction | Change % Extraction |
| Control | None | 2 | 5 | +3 |
| AMT | Air Dried | 67 | 21 | −46 |
| AMT | 130° C. for 5 Min | 57 | 21 | −36 |
| Co-Treat Na₂CO₃ | Air Dried | 56 | 13 | −43 |
| Co-Treat Na₂CO₃ | 130° C. for 5 Min | 54 | 18 | −36 |

Conclusions: Neither the high temperature drying or post treatment with carbonate improved strike rate or boiling durability compared to the antimicrobial by itself. It is postulated that insufficient amounts of both the antimicrobial agent and the carbonate were present for post treatment to be effective. Co-treatment with carbonate gave greatly improved strike rate and durability to boil compared to the control. One of the co-treated samples was boiled in 0.2 molar carbonate and produced improved durability after 30 minutes of boiling.

TABLE XII

| | | BOILED IN | |
|---|---|---|---|
| | NO BOIL % | WATER % | |
| CO-TREATMENT | EXTRACTION | EXTRACTION | CHANGE |
| CONTROL | 2 | 5 | +3 |
| AMT/AIR DRIED | 75 | 37 | −38 |
| AMT/130° C./5 minutes | 61 | 27 | −34 |
| AMT/130° C./30 minutes | 68 | 27 | −41 |
| AMT CO-TREAT/AIR | 85 | 82 | −3 |
| DRIED | | | |
| AMT CO-TREAT/AIR | 86 | 85 | −1 |
| DRIED | | | |
| BOILED IN 0.2 MOLAR | | | |
| SODIUM CARBONATE | | | |

Conclusions: High temperature drying at 130° C. did not improve the boiling durability of samples treated with antimicrobial or co-treated with carbonate and antimicrobial. Co-treatment with carbonate gave greatly improved strike rate and durability to boil compared to the control as measured by the BPB Extraction test. One of the co-treated samples was boiled in 0.2 molar carbonate and produced improved durability after 30 minutes of boiling.

TABLE XIII
Strike Rate - % BPB Extraction
AEM 5700 Plus Treatment - No Boil

| Sample | Alone | pH = 11 | Carbonate Co-Treat |
|---|---|---|---|
| PET | 4.98 | 62.57 | 66.43 |
| Rayon | 6.94 | 19.5 | 89.66 |
| Nylon | 8.01 | 45.1 | 93.64 |
| PET Staple | 17.36 | 75.82 | 98.41 |

Conclusions: The strike rate or application rate of antimicrobial to the substrate increases from AMT alone<AMT at pH=11<Carbonate Co-Treatment. A Carbonate co-treatment produces dramatically higher percent BPB Extraction indicating the presence of more antimicrobial on the substrate surface.

TABLE XIV
Boiling Durability - % BPB Extraction
AEM 5700 Plus Treatment - Boil 30 min.

| Sample | Alone | pH = 11 | Carbonate Co-Treat |
|---|---|---|---|
| PET | 17.9 | 14.38 | 23.32 |
| Rayon | 9.88 | 21.36 | 39.57 |
| Nylon | 14.42 | 17.83 | 33.92 |
| PET Staple | 6.82 | 37.6 | 57.42 |

Conclusions: The boiling durability of antimicrobial to the substrate increases from AMT alone<AMT at pH=11<Carbonate Co-Treatment. A Carbonate co-treatment produces dramatically higher percent BPB Extraction indicating the presence of more antimicrobial on the substrate surface.

TABLE XV

| | % BPB EXTRACTION @ 595 nm | | | |
|---|---|---|---|---|
| TREATMENT | COTTON | PPNW | NYLON | PET |
| CONTROL | 0 | 0 | 0 | 0 |
| AMT | 93 | 85 | 89 | 86 |
| AMT BOILED | 92 | 45 | 30 | 36 |
| % EXTRACTION CHANGE | −1 | −40 | −59 | −50 |

TABLE XVI

| | % BPB EXTRACTION @ 595 nm | | | |
|---|---|---|---|---|
| TREATMENT | COTTON | PPNW | NYLON | PET |
| CONTROL | 0 | 0 | 0 | 0 |
| AMT + PHOSPHATE | 92 | 59 | 80 | 82 |
| AMT + PHOSPHATE + | 81 | 72 | 80 | 81 |
| BOIL | | | | |
| % EXTRACTION CHANGE | −11 | +13 | 0 | −1 |

Conclusions: The phosphate co-treatment decreases the strike rate of the antimicrobial agent slightly compared to the AMT alone as measured by the % BPB Extraction. This is especially true for the cotton fabric. When the samples are boiled for 30 minutes in distilled water, the antimicrobial agent plus the phosphate co-treatment is seen to increase the durability significantly.

TABLE XVII
Boiling Durability

| | % BPB EXTRACTION @ 595 nm | | | |
|---|---|---|---|---|
| TREATMENT | NYLON | PET | ACRYLIC | PPNW |
| CONTROL | 0 | 0 | 0 | 0 |
| AMT | 80 | 83 | 56 | 77 |
| AMT + boiled | 26 | 19 | 14 | 37 |
| % EXTRACTION CHANGE | −54 | −64 | −42 | −40 |
| AMT + Oxalate | 47 | 104 | 105 | 104 |
| AMT + Oxalate + boiled | 79 | 106 | 102 | 101 |
| % Extraction Change | +32 | +2 | −3 | −3 |

* PPNW = polypropylene nonwoven fabric

Conclusions: The oxalate co-treatment dramatically increases the strike rate of the antimicrobial agent compared to the AMT alone as measured by the % BPB Extraction. The nylon fabric is an exception gives a lower strike rate using the co-treatment. When the samples are boiled for 30 minutes in distilled water, the antimicrobial agent plus the oxalate co-treatment is seen to increase the durability significantly in all samples.

What is claimed is:

1. A method of treating a solid substrate, the method comprising:
(I) providing a solid substrate;
(II) contacting the solid substrate with an aqueous solution of a at least one compound having a dianion, and thereafter,
(III) contacting the solid substrate from (II) with a silicon-containing material capable of reacting at or near the solid substrate surface.

2. A method as claimed in claim 1 wherein there is in addition, a catalyst present for the reaction of (III).

3. A method of treating a solid substrate, the method comprising:
(I) providing an aqueous solution of:
(i) at least one compound having a dianion and
(ii) a silicon-containing material capable of reacting at or near the surface of the solid substrate;
contacting the solid substrate with the an aqueous solution from (I).

4. A method as claimed in claim 3 wherein there is in addition, a catalyst present for the reaction potential in (ii).

5. A method of treating a solid substrate, the method comprising:
(A) providing an aqueous solution of a silicon-containing material;
(B) contacting the solid substrate with the aqueous solution from (A), and thereafter,
(C) contacting the solid substrate (B) with an aqueous solution of at least one compound having a dianion.

6. A method as claimed in claim 5 wherein there is in addition, a catalyst present in (C).

7. A method of treating a treated solid substrate, the method comprising:
(I) providing a chemically treated solid substrate,
(II) contacting the chemically treated solid substrate with an aqueous solution of at least one compound having a dianion, and thereafter,
(III) treating the solid substrate from (II) with a silicon-containing material capable of reacting with the at least the chemical used to chemically treat the solid substrate.

8. A method as claimed in claim 7 wherein in addition, there is a catalyst present for the potential reaction in (III).

9. A method of treating a treated solid substrate, the method comprising:
(I) providing a chemically treated solid substrate,
(II) treating the solid substrate with a silicon-containing material capable of reacting with the at least the chemical used to chemically treat the solid substrate and thereafter,
(III) contacting the treated solid substrate with an aqueous solution of at least one compound having a dianion.

10. A method as claimed in claim 9 wherein in addition, there is a catalyst present for the potential reaction in (III).

11. A method of treating a solid substrate, the method comprising:
(I) providing an aqueous solution of:
(i) at least one compound having a dianion and
(ii) a silicon-containing material capable of reacting at or near the surface of the solid substrate;
(II) contacting the solid substrate with the aqueous solution from (I).

12. A method as claimed in claim 11 wherein in addition, there is a catalyst present for the potential reaction in (ii)

13. The method as claimed in claim 1 wherein the dianion is selected from the group consisting essentially of:
a. SO₄⁻,
b. CO₃⁻,
c. HPO₄⁻,
d. Cr_{2O}₇⁻,
e. CrO₄⁻,
f. MnO₃⁻,
g. MnO₄⁻,
h. WO₄⁻, and
i. C₂O₄⁻.
j. mixtures of a.-i.

14. The method as claimed in claim 1 wherein the silicon-containing material is a silane.

15. The method as claimed in claim 14 wherein the silane is an organofunctional silane.

16. The method as claimed in claim 1 wherein the silicon-containing material is an alkoxy functional silane.

17. The method as claimed in claim 15 wherein the silane is an aminoorganofunctional silane.

18. The method as claimed in claim 17 wherein the aminoorganofunctional silane has the general formula:
(RO)ₙSi{(CₓH₂ₓ)N⁺(R²)_{b}(R³)_{3-b}X⁻}₄₋ₙ,
wherein ₙ has a value of 1, 2, or 3; ₓ has a value of 1 to 20; R is an alkyl group having 1 to 6 carbon atoms; each R² is an alkyl group selected from the group consisting of 1 to 6 carbon atoms, X is a halogen, each R³ is an alkyl group selected from the group consisting of 1 to twenty carbon atoms and b has a value of 0, 1, 2, or 3.

19. The method as claimed in claim 18 wherein R is a methyl radical, ₙ has a value of 3, ₓ has a value of 3, each R² is a methyl group.

20. The method as claimed in claim 1 wherein the solid substrate is selected from the group consisting essentially of:

| | | | |
|---|---|---|---|
| a. cotton, | b. polyester, | c. nylon, | d. rayon, |
| e. rubber, | f. fibers, | g. acrylic, | h. foams, |
| i. polypropylene, | j. polyethylene, | k. mineral, | l. polyurethane, |
| m. paper, | n. glass, | o. silica, | p. wood, |
| q. concrete, | r. other solid polymers, | s. other hard surfaces, and | |
| t. building products. | | | |

21. The method as claimed in claim 16 wherein the alkoxysilane is methyltrimethoxysilane.

22. The method as claimed in claim 16 wherein the alkoxysilane is trimethoxysilane.

23. The method as claimed in claim 1 wherein the silicon-containing material is an oligomer siloxane.

24. The method as claimed in claim 1 wherein the silicon-containing material is a polymeric siloxane.

25. The method as claimed in claim 1 wherein the silicon-containing material is a disilane.

26. The method as claimed in claim 1 wherein the silicon-containing material contains an —Si(C)_{y}Si—linkage.

27. The method as claimed in claim 26 wherein y has a value of from 1 to 12.

28. The method as claimed in claim 1 wherein the silicon-containing material is a silicone/organic copolymer.

29. A solid substrate when treated by the method of claim 1.
